(19) United States
(12) Patent Application Publication
(10) Pub. No.: US 2023/0289280 A1
(43) Pub. Date: Sep. 14, 2023

(54) METHODS, APPARATUSES, AND COMPUTER READABLE MEDIA FOR SOFTWARE DEVELOPMENT, TESTING AND MAINTENANCE

(71) Applicant: Nokia Solutions and Networks Oy, Espoo (FI)

(72) Inventors: Xiaoyan YUAN, Qingdao (CN); Shanjing TANG, Qingdao (CN); Qingfang MENG, Qingdao (CN)

(21) Appl. No.: 18/041,114

(22) PCT Filed: Aug. 28, 2020
(86) PCT No.: PCT/CN2020/112088

§ 371 Date: Feb. 9, 2023

(51) Int. Cl. G06F 11/36

(52) U.S. Cl. CPC G06F 11/3612; G06F 11/3688

(57) ABSTRACT

Methods, apparatuses and computer readable media for software development, test, and maintenance are provided. An example method includes obtaining a feature data set corresponding to a raw data set associated with a software product, determining at least one similarity value group for the feature data set, determining at least one unified similarity factor with at least one weight for the at least one similarity consideration to the at least one similarity value group, adjusting the at least one weight so that a deviation between the at least one unified similarity factor and at least one reference unified similarity factor is below a predetermined threshold, and building a corpus comprising information on the feature data set and the at least one weight.

### TECHNICAL FIELD

Various embodiments relate to methods, apparatuses, and computer readable media for software development, testing and maintenance.

### BACKGROUND

In a life cycle of a software system or product, large efforts may be spent for example in developments, tests, maintenances, and so on. For example, for a large scaled software product, a lot of efforts may be spent in locating the source codes to be modified and test cases related to the modified part, locating root causes for an issue and finding out solutions, or the like.

### SUMMARY

In a first aspect, disclosed is a method including: obtaining a feature data set corresponding to a raw data set associated with a software product, feature data in the feature data set comprising at least one feature data item in terms of at least one similarity consideration for raw data in the raw data set; determining at least one similarity value group for the feature data set, a similarity value group comprising at least one similarity value between at least one feature data item in first feature data in the feature data set and at least one feature data item in second feature data in the feature data set; determining at least one unified similarity factor with at least one weight for the at least one similarity consideration to the at least one similarity value group; adjusting the at least one weight so that a deviation between the at least one unified similarity factor and at least one reference unified similarity factor is below a predetermined threshold; and building a corpus comprising information on the feature data set and the at least one weight.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the method may further include determining at least one category for the feature data set.

In some embodiments, the raw data in the raw data set may include at least one of: runtime data associated with the software product, software runtime footprint tree data associated with the software product, historical data associated with the software product, an issue description associated with the software product, at least one network package associated with the software product, at least one log associated with the software product, at least one source code associated with the software product, at least one test case associated with the software product, at least one file associated with the software product, at least one develop document associated with the software product, and at least one solution collection associated with the software product.

In some embodiments, the method may further include associating at least one feature data in the feature data set with at least one of at least one software code of the software product or at least one test case of the software product.

In some embodiments, the method may further include extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature. In some embodiments, the method may further include determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the method may further include determining at least one automatic code generation recommendation for respective requirement based on the at least one feature data items of respective requirement.

In some embodiments, the method may further include monitoring the software product to obtain the raw data set associated with software product at runtime.

In a second aspect, disclosed is an apparatus which may be configured to perform at least the method in the first aspect. The apparatus may include at least one processor and at least one memory. The at least one memory may include computer program code, and the at least one memory and the computer program code may be configured to, with the at least one processor, cause the apparatus to perform: obtaining a feature data set corresponding to a raw data set associated with a software product, feature data in the feature data set comprising at least one feature data item in terms of at least one similarity consideration for raw data in the raw data set; determining at least one similarity value group for the feature data set, a similarity value group comprising at least one similarity value between at least one feature data item in first feature data in the feature data set and at least one feature data item in second feature data in the feature data set; determining at least one unified similarity factor with at least one weight for the at least one similarity consideration to the at least one similarity value group; adjusting the at least one weight so that a deviation between the at least one unified similarity factor and at least one reference unified similarity factor is below a predetermined threshold; and building a corpus comprising information on the feature data set and the at least one weight.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the at least one memory and the computer program code may be configured to, with the at least one processor, cause the apparatus to further perform determining at least one category for the feature data set.

In some embodiments, the raw data in the raw data set may include at least one of: runtime data associated with the software product, software runtime footprint tree data associated with the software product, historical data associated with the software product, an issue description associated with the software product, at least one network package associated with the software product, at least one log associated with the software product, at least one source code associated with the software product, at least one test case associated with the software product, at least one file associated with the software product, at least one develop document associated with the software product, and at least one solution collection associated with the software product.

In some embodiments, the at least one memory and the computer program code may be configured to, with the at least one processor, cause the apparatus to further perform associating at least one feature data in the feature data set with at least one of at least one software code of the software product or at least one test case of the software product.

In some embodiments, the at least one memory and the computer program code may be configured to, with the at least one processor, cause the apparatus to further perform extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature. In some embodiments, the at least one memory and the computer program code may be configured to, with the at least one processor, cause the apparatus to further perform determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the at least one memory and the computer program code may be configured to, with the at least one processor, cause the apparatus to further perform determining at least one automatic code generation recommendation for respective requirement based on the at least one feature data items of respective requirement.

In some embodiments, the at least one memory and the computer program code may be configured to, with the at least one processor, cause the apparatus to further perform monitoring the software product to obtain the raw data set associated with software product at runtime.

In a third aspect, disclosed is an apparatus which may be configured to perform at least the method in the first aspect. The apparatus may include: means for obtaining a feature data set corresponding to a raw data set associated with a software product, feature data in the feature data set comprising at least one feature data item in terms of at least one similarity consideration for raw data in the raw data set; means for determining at least one similarity value group for the feature data set, a similarity value group comprising at least one similarity value between at least one feature data item in first feature data in the feature data set and at least one feature data item in second feature data in the feature data set; means for determining at least one unified similarity factor with at least one weight for the at least one similarity consideration to the at least one similarity value group; means for adjusting the at least one weight so that a deviation between the at least one unified similarity factor and at least one reference unified similarity factor is below a predetermined threshold; and means for building a corpus comprising information on the feature data set and the at least one weight.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the apparatus may further include means for determining at least one category for the feature data set.

In some embodiments, the raw data in the raw data set may include at least one of: runtime data associated with the software product, software runtime footprint tree data associated with the software product, historical data associated with the software product, an issue description associated with the software product, at least one network package associated with the software product, at least one log associated with the software product, at least one source code associated with the software product, at least one test case associated with the software product, at least one file associated with the software product, at least one develop document associated with the software product, and at least one solution collection associated with the software product.

In some embodiments, the apparatus may further include means for associating at least one feature data in the feature data set with at least one of at least one software code of the software product or at least one test case of the software product.

In some embodiments, the apparatus may further include means for extracting at least one first feature of at least one requirement from at least one file or description associated with the software product, means for extracting at least one second feature from at least one historical records associated the source codes of the software product, and means for associating respective requirement of the at least one requirement with at least one executive unit based on the at least one first feature and the at least one second feature. In some embodiments, the apparatus may further include means for determining at least one execution case associated with the at least one executive unit, and means for determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the apparatus may further include means for determining at least one automatic code generation recommendation for respective requirement based on the at least one feature data items of respective requirement.

In some embodiments, the apparatus may further include means for monitoring the software product to obtain the raw data set associated with software product at runtime.

In a fourth aspect, a computer readable medium is disclosed. The computer readable medium may include instructions stored thereon for causing an apparatus to perform the method in the first aspect. The instructions may cause the apparatus to perform: obtaining a feature data set corresponding to a raw data set associated with a software product, feature data in the feature data set comprising at least one feature data item in terms of at least one similarity consideration for raw data in the raw data set; determining at least one similarity value group for the feature data set, a similarity value group comprising at least one similarity value between at least one feature data item in first feature data in the feature data set and at least one feature data item in second feature data in the feature data set; determining at least one unified similarity factor with at least one weight for the at least one similarity consideration to the at least one similarity value group; adjusting the at least one weight so that a deviation between the at least one unified similarity factor and at least one reference unified similarity factor is below a predetermined threshold; and building a corpus comprising information on the feature data set and the at least one weight.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the instructions may cause the apparatus to further perform determining at least one category for the feature data set.

In some embodiments, the raw data in the raw data set may include at least one of: runtime data associated with the software product, software runtime footprint tree data associated with the software product, historical data associated with the software product, an issue description associated with the software product, at least one network package associated with the software product, at least one log associated with the software product, at least one source code associated with the software product, at least one test case associated with the software product, at least one file associated with the software product, at least one develop document associated with the software product, and at least one solution collection associated with the software product.

In some embodiments, the instructions may cause the apparatus to further perform associating at least one feature data in the feature data set with at least one of at least one software code of the software product or at least one test case of the software product.

In some embodiments, the instructions may cause the apparatus to further perform extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature. In some embodiments, the instructions may cause the apparatus to further perform determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the instructions may cause the apparatus to further perform determining at least one automatic code generation recommendation for respective requirement based on the at least one feature data items of respective requirement.

In some embodiments, the instructions may cause the apparatus to further perform monitoring the software product to obtain the raw data set associated with software product at runtime.

In a fifth aspect, disclosed is a method including: obtaining first feature data comprising at least one first feature data item in terms of at least one similarity consideration for raw data associated with a software product; obtaining second feature data from a corpus associated with the software product, the second feature data comprising at least one second feature data item in terms of the at least one similarity consideration; determining at least one similarity value between the at least one first feature item and at least one second feature item; determining a unified similarity factor between the first feature data and the second feature data with at least one weight for the at least one similarity consideration to the at least one similarity value; and generating a recommendation on the software product based on the unified similarity factor.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the recommendation may include at least one of: selecting at least one test case associated with the first feature data and at least one test case associated with the second feature data in a case where the unified similarity factor is below the predetermined threshold; providing at least one of at least one recommendation item associated with the second feature data, at least one source code of the software product associated with the second feature data, or at least one test case of the software product associated with the second feature data, in a case where the unified similarity factor is above the predetermined threshold; re-executing the software product with at least one recommended configuration parameter associated with the second feature data in a case where the unified similarity factor is above the predetermined threshold; or executing a set of test cases associated with the software product. For example, the recommendations may be performed automatically.

In some embodiments, the method may further include determining a category of the first data to obtain the second data from the corpus based on the category.

In some embodiments, the solution recommendation may be generated based on at least one of the category or at least one feature data in the corpus in case where the unified similarity factor is below a predetermined threshold, where the at least one feature data belongs to the category and at least one unified similarity factor between the at least one feature data and the first feature data being above another predetermined threshold.

In some embodiments, the method may further include obtaining the raw data associated with the software product and obtaining the first feature data based on the raw data, where the raw data may include at least one of: runtime data associated with the software product, software runtime footprint tree data associated with the software product, historical data associated with the software product, an issue description associated with the software product, at least one network package associated with the software product, at least one log associated with the software product, at least one code associated with the software product, at least one test case associated with the software product, at least one file associated with the software product, at least one develop document associated with the software product, and at least one solution collection associated with the software product.

In some embodiments, the method may further include associating the first feature data with at least one of at least one software code or at least one test case associated with the software product.

In some embodiments, the method may further include extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature. In some embodiments, the method may further include determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the method may further include determining at least one automatic code generation recommendation for respective requirement based on the at least one feature data items of respective requirement.

In some embodiments, the method may further include monitoring the software product to obtain the raw data corresponding to the first feature data at runtime.

In some embodiments, the method may further include adjusting the at least one weight in a case where unified similarity factors between one or more feature data in the corpus and the first feature data are below a predetermined threshold.

In a sixth aspect, disclosed is an apparatus which may be configured to perform at least the method in the sixth aspect. The apparatus may include at least one processor and at least one memory. The at least one memory may include computer program code, and the at least one memory and the computer program code may be configured to, with the at least one processor, cause the apparatus to perform: obtaining first feature data comprising at least one first feature data item in terms of at least one similarity consideration for raw data associated with a software product; obtaining second feature data from a corpus associated with the software product, the second feature data comprising at least one second feature data item in terms of the at least one similarity consideration; determining at least one similarity value between the at least one first feature item and at least one second feature item; determining a unified similarity factor between the first feature data and the second feature data with at least one weight for the at least one similarity consideration to the at least one similarity value; and generating a recommendation on the software product based on the unified similarity factor.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the recommendation may include at least one of: selecting at least one test case associated with the first feature data and at least one test case associated with the second feature data in a case where the unified similarity factor is below the predetermined threshold; providing at least one of at least one recommendation item associated with the second feature data, at least one source code of the software product associated with the second feature data, or at least one test case of the software product associated with the second feature data, in a case where the unified similarity factor is above the predetermined threshold; re-executing the software product with at least one recommended configuration parameter associated with the second feature data in a case where the unified similarity factor is above the predetermined threshold; or executing a set of test cases associated with the software product. For example, the recommendations may be performed automatically.

In some embodiments, the at least one memory and the computer program code may be configured to, with the at least one processor, cause the apparatus to further perform determining a category of the first data to obtain the second data from the corpus based on the category.

In some embodiments, the solution recommendation may be generated based on at least one of the category or at least one feature data in the corpus in case where the unified similarity factor is below a predetermined threshold, where the at least one feature data belongs to the category and at least one unified similarity factor between the at least one feature data and the first feature data being above another predetermined threshold.

In some embodiments, the at least one memory and the computer program code may be configured to, with the at least one processor, cause the apparatus to further perform obtaining the raw data associated with the software product and obtaining the first feature data based on the raw data, where the raw data may include at least one of: runtime data associated with the software product, software runtime footprint tree data associated with the software product, historical data associated with the software product, an issue description associated with the software product, at least one network package associated with the software product, at least one log associated with the software product, at least one code associated with the software product, at least one test case associated with the software product, at least one file associated with the software product, at least one develop document associated with the software product, and at least one solution collection associated with the software product.

In some embodiments, the at least one memory and the computer program code may be configured to, with the at least one processor, cause the apparatus to further perform associating the first feature data with at least one of at least one software code or at least one test case associated with the software product.

In some embodiments, the at least one memory and the computer program code may be configured to, with the at least one processor, cause the apparatus to further perform extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature. In some embodiments, the at least one memory and the computer program code may be configured to, with the at least one processor, cause the apparatus to further perform determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the at least one memory and the computer program code may be configured to, with the at least one processor, cause the apparatus to further perform determining at least one automatic code generation recommendation for respective requirement based on the at least one feature data items of respective requirement.

In some embodiments, the at least one memory and the computer program code may be configured to, with the at least one processor, cause the apparatus to further perform monitoring the software product to obtain the raw data corresponding to the first feature data at runtime.

In some embodiments, the at least one memory and the computer program code may be configured to, with the at least one processor, cause the apparatus to further perform adjusting the at least one weight in a case where unified similarity factors between one or more feature data in the corpus and the first feature data are below a predetermined threshold.

In a seventh aspect, disclosed is an apparatus which may be configured to perform at least the method in the first aspect. The apparatus may include: means for obtaining first feature data comprising at least one first feature data item in terms of at least one similarity consideration for raw data associated with a software product; means for obtaining second feature data from a corpus associated with the software product, the second feature data comprising at least one second feature data item in terms of the at least one similarity consideration; means for determining at least one similarity value between the at least one first feature item and at least one second feature item; means for determining a unified similarity factor between the first feature data and the second feature data with at least one weight for the at least one similarity consideration to the at least one similarity value; and means for generating a recommendation on the software product based on the unified similarity factor.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the recommendation may include at least one of: selecting at least one test case associated with the first feature data and at least one test case associated with the second feature data in a case where the unified similarity factor is below the predetermined threshold; providing at least one of at least one recommendation item associated with the second feature data, at least one source code of the software product associated with the second feature data, or at least one test case of the software product associated with the second feature data, in a case where the unified similarity factor is above the predetermined threshold; re-executing the software product with at least one recommended configuration parameter associated with the second feature data in a case where the unified similarity factor is above the predetermined threshold; or executing a set of test cases associated with the software product. For example, the recommendations may be performed automatically.

In some embodiments, the apparatus may further include means for determining a category of the first data to obtain the second data from the corpus based on the category.

In some embodiments, the solution recommendation may be generated based on at least one of the category or at least one feature data in the corpus in case where the unified similarity factor is below a predetermined threshold, where the at least one feature data belongs to the category and at least one unified similarity factor between the at least one feature data and the first feature data being above another predetermined threshold.

In some embodiments, the apparatus may further include means for obtaining the raw data associated with the software product and means for obtaining the first feature data based on the raw data, where the raw data may include at least one of: runtime data associated with the software product, software runtime footprint tree data associated with the software product, historical data associated with the software product, an issue description associated with the software product, at least one network package associated with the software product, at least one log associated with the software product, at least one code associated with the software product, at least one test case associated with the software product, at least one file associated with the software product, at least one develop document associated with the software product, and at least one solution collection associated with the software product.

In some embodiments, the apparatus may further include means for associating the first feature data with at least one of at least one software code or at least one test case associated with the software product.

In some embodiments, the apparatus may further include means for extracting at least one first feature of at least one requirement from at least one file or description associated with the software product, means for extracting at least one second feature from at least one historical records associated the source codes of the software product, and means for associating respective requirement of the at least one requirement with at least one executive unit based on the at least one first feature and the at least one second feature. In some embodiments, the apparatus may further include means for determining at least one execution case associated with the at least one executive unit, and means for determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the apparatus may further include means for determining at least one automatic code generation recommendation for respective requirement based on the at least one feature data items of respective requirement.

In some embodiments, the apparatus may further include means for monitoring the software product to obtain the raw data corresponding to the first feature data at runtime.

In some embodiments, the apparatus may further include means for e adjusting the at least one weight in a case where unified similarity factors between one or more feature data in the corpus and the first feature data are below a predetermined threshold.

In an eighth aspect, a computer readable medium is disclosed. The computer readable medium may include instructions stored thereon for causing an apparatus to perform the method in the first aspect. The instructions may cause the apparatus to perform: obtaining first feature data comprising at least one first feature data item in terms of at least one similarity consideration for raw data associated with a software product; obtaining second feature data from a corpus associated with the software product, the second feature data comprising at least one second feature data item in terms of the at least one similarity consideration; determining at least one similarity value between the at least one first feature item and at least one second feature item; determining a unified similarity factor between the first feature data and the second feature data with at least one weight for the at least one similarity consideration to the at least one similarity value; and generating a recommendation on the software product based on the unified similarity factor.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the recommendation may include at least one of: selecting at least one test case associated with the first feature data and at least one test case associated with the second feature data in a case where the unified similarity factor is below the predetermined threshold; providing at least one of at least one recommendation item associated with the second feature data, at least one source code of the software product associated with the second feature data, or at least one test case of the software product associated with the second feature data, in a case where the unified similarity factor is above the predetermined threshold; re-executing the software product with at least one recommended configuration parameter associated with the second feature data in a case where the unified similarity factor is above the predetermined threshold; or executing a set of test cases associated with the software product. For example, the recommendations may be performed automatically.

In some embodiments, the instructions may cause the apparatus to further perform determining a category of the first data to obtain the second data from the corpus based on the category.

In some embodiments, the solution recommendation may be generated based on at least one of the category or at least one feature data in the corpus in case where the unified similarity factor is below a predetermined threshold, where the at least one feature data belongs to the category and at least one unified similarity factor between the at least one feature data and the first feature data being above another predetermined threshold.

In some embodiments, the instructions may cause the apparatus to further perform obtaining the raw data associated with the software product and obtaining the first feature data based on the raw data, where the raw data may include at least one of: runtime data associated with the software product, software runtime footprint tree data associated with the software product, historical data associated with the software product, an issue description associated with the software product, at least one network package associated with the software product, at least one log associated with the software product, at least one code associated with the software product, at least one test case associated with the software product, at least one file associated with the software product, at least one develop document associated with the software product, and at least one solution collection associated with the software product.

In some embodiments, the instructions may cause the apparatus to further perform associating the first feature data with at least one of at least one software code or at least one test case associated with the software product.

In some embodiments, the instructions may cause the apparatus to further perform extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature. In some embodiments, the instructions may cause the apparatus to further perform determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit. In some embodiments, the instructions may cause the apparatus to further perform determining at least one automatic code generation recommendation for respective requirement based on the at least one feature data items of respective requirement.

In some embodiments, the instructions may cause the apparatus to further perform monitoring the software product to obtain the raw data corresponding to the first feature data at runtime.

In some embodiments, the instructions may cause the apparatus to further perform adjusting the at least one weight in a case where unified similarity factors between one or more feature data in the corpus and the first feature data are below a predetermined threshold.

### BRIEF DESCRIPTION OF THE DRAWINGS

Some embodiments will now be described, by way of non-limiting examples, with reference to the accompanying drawings.

FIG. 1 illustrates an example solution for solution recommendation a software product in an embodiment.

FIG. 2 illustrates an example of obtaining raw data in an embodiment.

FIG. 3A illustrates an example of extracting feature data in an embodiment.

FIG. 3B illustrates another example of extracting feature data in an embodiment.

FIG. 3C illustrates another example of extracting feature data in an embodiment.

FIG. 4 illustrates an example of data in a corpus in an embodiment.

FIG. 5 illustrates an example method for building corpus for solution recommendation a software product in an embodiment.

FIG. 6 illustrates an example apparatus for building corpus for solution recommendation a software product in an embodiment.

FIG. 7 illustrates an example apparatus for building corpus for solution recommendation a software product in an embodiment.

FIG. 8 illustrates an example method for solution recommendation a software product in an embodiment.

FIG. 9 illustrates an example apparatus for solution recommendation a software product in an embodiment.

FIG. 10 illustrates an example apparatus for solution recommendation a software product in an embodiment.

### DETAILED DESCRIPTION

In a life cycle of a software product (or system), large efforts may be spent in many aspects such as developments, tests, maintenances. For example, for a large scaled software product, in a case where there are coming new requirements, developers of the software product may spend a lot of efforts in locating the source codes to be modified, source codes which may be affected, test cases related to the modified part, or the like, which may delay Time to Market (TTM). Further, there may be similarity or duplication among possibly a large number or even massive test cases, which may delay TTM. In addition, for issues of the software product, the developers or maintainers of the software product may spend lots of efforts in locating root causes and finding out solutions.

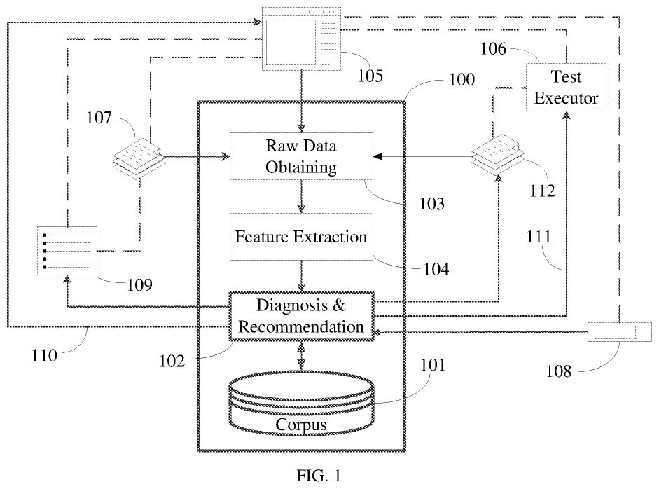

FIG. 1 illustrates an example solution 100 for providing recommendations related to at least one of development, testing, or maintenance of a software product in an embodiment, where a corpus 101 associated at least with a software product 105 is involved, based on which the example solution 100 may perform a diagnosis and/or generate recommendations related to at least one of development, testing, or maintenance of the software product 105, for example automatically in a part 102.

As illustrated in FIG. 1, in an embodiment, the example solution 100 may obtain/collect raw data (for example, automatically) in a part 103 from one or more sources such as the software product 105 (for example including messages, logs, return codes, network packages, and so on, which are output or used by the software product 105), a development document 107 for one or more enhancements of the software product 105, one or more test cases 112 for the software product 105, source codes of the software product 105, and so on. Then, the example solution 100 may extract one or more features in a part 104 from the raw data obtained/collected in the part 103, and may perform the diagnosis and/or provide the recommendation based on the one or more extracted features and data in the corpus 101.

For example, the raw data may include, but are not limited to, one or more of: runtime data of the software product 105 (e.g. software runtime footprint tree data output by the software product 105), historical data of the software product 105, one or more issue descriptions and/or error/exceptions output by the software product 105, one or more network packages associated with the software product 105, one or more logs of the software product 105, one or more source codes of the software product 105, one or more test cases for the software product 105, one or more files (e.g. the development document 107) associated with the software product 105, one or more solutions for the software product 105, or the like.

For example, depending on a recommendation level to be expected (for example, a recommendation on development of the software product 105, a recommendation on a test of the software product 105, a recommendation on an issue of the software product 105, etc.), a category of the raw data (for example, a raw data related to an issue of the software product 105, a raw data related to a development of the software product 105 such as the develop document 107, etc.), a similarity match result between the one or more extracted features and the data in the corpus 101, and so on, the recommendation provided by the part 102 may include, but is not limited to, one or more of: outputting one or more solutions or one or more feature presentations of the solutions for one or more issue descriptions and/or errors/exceptions output by the software product 105, which may be for example included in one or more recommendation items 109; re-executing (for example, automatically) the software product 105 with one or more recommended configuration parameters, for example as illustrated by the arrow 110 in FIG. 1; outputting one or more recommended configuration parameters for re-executing the software product 105, which may be for example also included in one or more recommendation items 109; triggering (for example, automatically) a test executor 106 to execute a set of test cases for example associated with the one or more issue descriptions and/or error/exceptions output by the software product 105 or one or more enhanced features/functions of the software product 105, as illustrated by the arrow 111 in FIG. 1; outputting one or more code logics, one or more test cases, one or more call flows, one or more automatically generated code parts, or the like associated with the development document 107, which may also be included in one or more recommendation items 109; or the like.

In another embodiment, in addition to or in lieu of providing recommendations based on the raw data obtained in the part 103, as illustrated in FIG. 1, the recommendation in the part 102 may be also performed in response to an input 108. For example, a tester of the software product 105 may input an instruction to perform a test for one or more functions of the software product 105 via an interface of the example solution 100, where the instruction may include information on one or more parameters associated with the expected test or test cases, for example a similarity threshold for selecting test cases. Then, in respond to the instruction from the input 108, the part 102 may perform the recommendation based on the corpus 101, for example by selecting (for example, automatically) one or more test cases 112 from the corpus 101, or by selecting, from another database, or one or more test cases 112 which correspond to one or more data items in the corpus 101 determined by the part 102. Further, for example, the recommendation provided by the part 102 may also include triggering (for example, automatically) the test executor 106 to execute the one or more selected test cases, and/or outputting test results of the one or more selected test cases. It is appreciated that, in various embodiments, the recommendations may be performed/provided automatically, semi-automatically (for example, including one or more manual operations such as button clicking or the like), or manually. For example, the recommendations may also include one or more actions such as adjusting one or more software or network configuration parameters, clicking some buttons, inputting information on testing (e.g. test coverage), for example manually before running one or more test cases.

More details of the example solution 100 will be described below by means of one or more non-limited examples.

As a basis of the recommendation of the example solution 100, the corpus 101 may be configured (for example, in advance) based on raw data collected for the software product 105 by the part 103, where the corpus 101 may include a feature data set corresponding to a raw data set associated with the software product 105. For a piece of feature data in the feature data set in the corpus 101, the feature data may correspond to an execution case (e.g. a test case) of the software product 105 and may include one or more feature data items in terms of one or more similarity considerations for the raw data associated with the software product 105. In some embodiments, the corpus 101 may also be adjusted at runtime, for example based on the raw data collected by the part 103 and the recommendation results. In various embodiments, the corpus 101 may be configured to use one or more databases and/or files to store the data.

In various embodiment, various types of the raw data may be captured or collected in the part 103, such as runtime data of the software product 105 (e.g. software runtime footprint tree data output by the software product 105), historical data of the software product 105, one or more issue descriptions and/or error/exceptions output by the software product 105, one or more network packages associated with the software product 105, one or more logs of the software product 105, one or more source codes of the software product 105, one or more test cases for the software product 105, one or more files (e.g. the development document 107) associated with the software product 105, one or more solutions for the software product 105, or the like. Accordingly, any suitable manners may be adopted in the part 103 to collect the raw data for configuring the corpus 101.

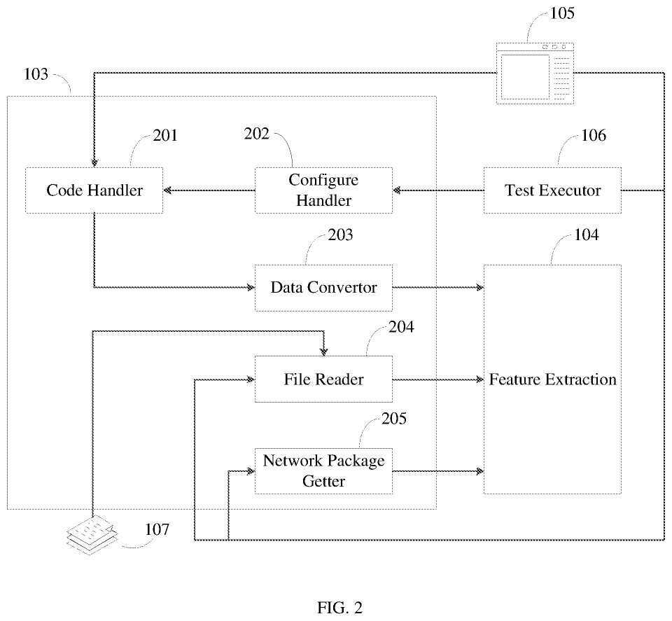

For example, runtime data of the software product 105 (e.g. software runtime footprint tree data output by the software product 105) may be obtained based on one or more logs (e.g. trace logs or debug logs) of the software product 105. In another example, as illustrated in FIG. 2, in an embodiment, the part 103 may include a coder handler 201, a configure handler 202, and a data convertor 203, so that the part 103 may capture runtime information of the software product 105, such as runtime footprint tree data of the software product 105.

For example, in a case where the software product 105 is implemented in C/C++ and complied with gcc (GNU Compiler Collection), one or more options such as an option “-finstrument-functions” may be used at the time of compiling and linking. The “-finstrument-functions” option is originally designed for profiling purposes. GCC documentation has detailed description on how it is used, for example, https://gcc.gnu.org/onlinedocs/gcc-4.4.7/gcc/Code-Gen-Options.html. With this flag, two special functions_cyg_profile_func_enter( ) and cyg_profile_func_exit( ) can print function call stack. These functions are called automatically when entering a function and when exiting the function, respectively. Then, the software product 105 may output software runtime footprint tree data automatically during its execution. In a case where the software product 105 is implemented in other programming languages such as Java or Python, a Java agent or a Python run library module with a similar function may be used so as to enable the software product 105 to output for example software runtime footprint tree data. Further, for example, the code handler 201 may be implemented as a component or a link library which may be embedded or linked into the software product 105, so that information such as software runtime footprint tree data and/or function call logs of the software product 105 may be captured automatically by the code handler 201. Thus, for example errors and inconsistence due to manual collection of function call information may be avoided. For example, formats and/or contents of trace logs and/or debug logs which are output by means of one or more source codes included explicitly in source codes of the software product 105 may subject to developers of the software product 105, which may lack some information possibly useful for later issue location. For example, inconsistence or lacks of necessary information for later issue analyses and locations may be reduced or avoided by using options such as “-finstrument-functions” when compiling and/or linking the software product 105, or by means of Java agent or Python run library module.

For example, the runtime information of the software product 105, which may be collected automatically by the code handler 201, may include, but is not limited to, one or more of: software code entity metadata associated with one or more execution cases (e.g. one or more test cases) of the software product 105, such as function/method names, function/method parameters involved in the one or more execution cases; calling order/sequence of software executable units (e.g. functions, methods, and so on) associated with one or more execution cases (e.g. one or more test cases) of the software product 105, for example information on a first function being called before a second function but after a third function in an execution case, or the like; execution times of one or more executable units associated with one or more execution cases (e.g. one or more test cases) of the software product 105; calling width associated with one or more execution cases (e.g. one or more test cases) of the software product 105; calling depth associated with one or more execution cases (e.g. one or more test cases) of the software product 105; or the like.

For example, the configure handler 202 may receive, from the test executor 106, an instruction (e.g. via a network message such as a hypertext transfer protocol message) to inform that a test case (e.g. with an identifier “TC-XX”) for the software product 105 starts. Then, the configure handler 202 may notify the code handler 201 that the test case TC-XX is in-progress for example via a shared memory. In response to the notification from the configure handler 202, the code handler 201 may start to capture runtime information associated with the test case TC-XX of the software product 105.

In another example, as illustrated in FIG. 2, the code handler 201 may also be triggered (for example, automatically) by the software product 105 when the software product 105 starts or re-start, for example based on a configuration parameter of the software product 105 which indicates to activate the code handler 201 when the software product 105 starts. In an example, the code handler 201 may be configured to buffer runtime information for a period of time, and to output at least a part of buffered run-time information of the software product 105 as a part of the raw data for recommendation, for example in response to an issue (e.g. an error, an exception, a warning, or the like) generated by the software product 105.

The code handler 201 may output data in any suitable form or format to the data convertor 203. For example, the code handler 201 may capture and output the runtime data of the software product 105 in a compact data format which may be human unreadable. Then, the data convertor 203 may convert the data from the code handler 201 into a form/format which may be convenient for subsequent processes such as feature extrication in the part 104 or which may be human readable. For example, the raw data captured at runtime by the code handler 201 may include memory addresses of called functions, integers corresponding to e.g. timestamps of calling functions and a status of the test case TC-XX, and the convertor 203 may convert/translate memory addresses and the integers into corresponding function names and strings which may be human readable. In an example, the data convertor 203 may be configured to operate in response to an instruction from the test executor 106 (e.g. via a network message such as a hypertext transfer protocol message), which informs that one or more test cases including the test case TC-XX for the software product 105 has finished.

In addition, as illustrated in FIG. 2, the part 103 may also include a file reader 204, which may be configured to read and parse one or more files such as one or more logs of the software product 105 and/or the test executor 106 for the software product 105. For example, the file reader 204 may be configured to read one or more specified logs periodically or in response to an issue of the software product 105. In another example, as illustrated in FIG. 2, the file reader 204 may be configured to read the development document 107 of the software product 105, which may include specifications/definitions of one or more enhanced logics/features/functions and/or related test cases of the software product 105.

Further, as illustrated in FIG. 2, the part 103 may also include a network package getter 205 for capturing/obtaining network packages related to the software product 105. For example, the network package getter 205 may include a sniffer.

It is appreciated that both the raw data which may be captured or obtained by the part 103 of the example solution 100 and the implementation of the part 103 are not limited to the above examples.

After obtaining the raw data set in the part 103, a feature data set may be obtained/extracted in the part 104 based on the obtained raw data set.

For example, for a piece of collected raw data associated with an execution case (e.g. a test case) of the software product 105, the part 104 may be configured to extract one or more features in the following one or more non-limited example aspects (which is also called as “similarity considerations” herein): (A) an execution order of one or more executable units associated with the execution case; (B) execution numbers of respective executable units associated with the execution case; (C) an execution depth of one or more executable units associated with the execution case; (D) an execution width of one or more executable units associated with the execution case; (E) information for determining correlation (e.g. Jaccard coefficients) for example among the network packages associated with the execution case; (F) semantics of a description (e.g. a description of an issue) associated with the execution case; (G) one or more topics of a text (e.g. texts of one or more logs) associated with the execution case; or the like. Thus, for a piece of feature data associated with an execution case of the software product 105, the feature data may include one or more feature data items corresponding to the above one or more similarity considerations, respectively.

In an embodiment, in the part 104, feature data items in the above example aspects (A), (B), (C), and (D) may be determined for example based on the software runtime footprint tree data captured for the software product 105 at runtime by the above code handler 201, or one or more logs such as trace logs or debug logs output by the software product 105.

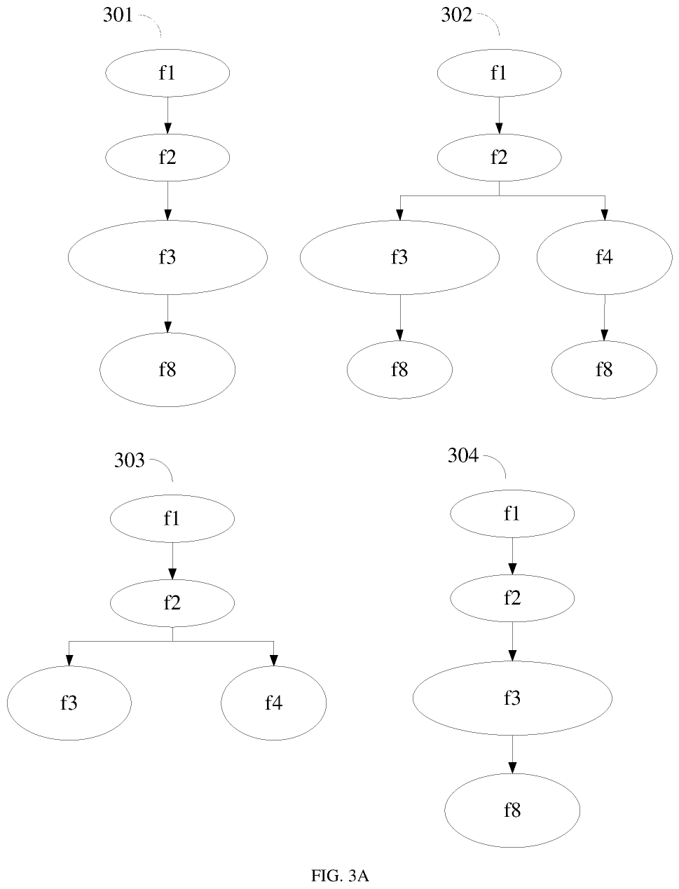

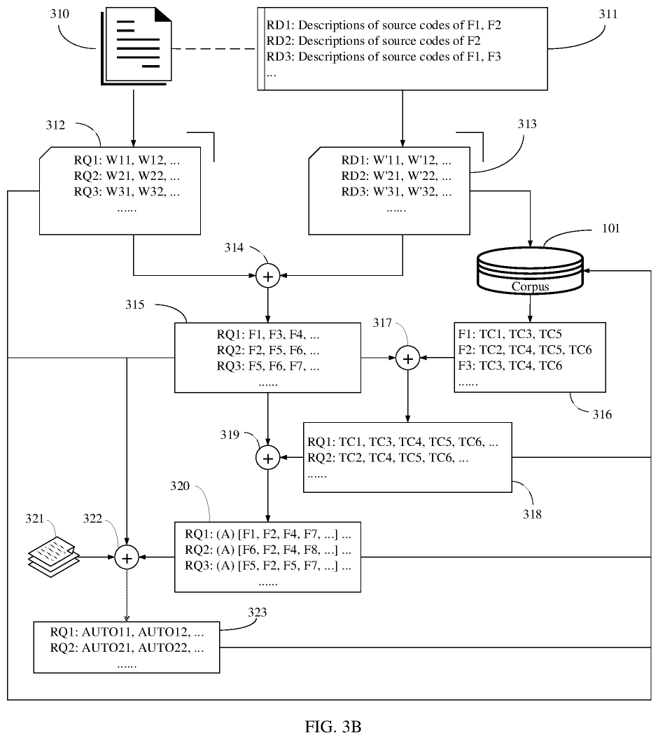

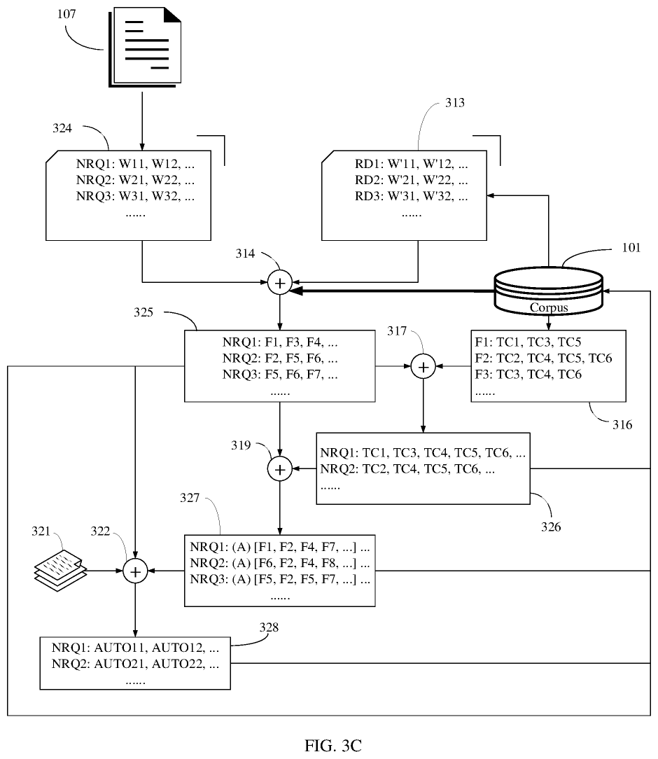

FIG. 3A illustrates 4 example spanning trees visualizing 4 pieces of software runtime footprint tree data captured for 4 execution cases (e.g. 4 test cases) of the software product 105, where a node in a spanning tree represents an executable unit in an execution case, an arrow between two nodes represents an execution order of two executable units, and a size of a node represents execution times of the executable unit represented by the node. Then, the feature data items for the execution cases 301, 302, 303, and 304 in the aspects (A), (B), (C) and (D) may be determined based on the structure of the spanning trees and information of nodes in the spanning trees, or by parsing the software runtime footprint tree data. The following Table 1 illustrates the feature data items for the execution cases 301, 302, 303, and 304 in the aspects (A), (B), (C) and (D) which are determined based on the software runtime footprint tree data captured for the software product 105.

TABLE 1

| | (A) Execution | (B) Execution | | |
|---|---|---|---|---|
| Case | Order | Times | (C) Depth | (D) Width |
| 301 | {[f1, f2, f3, f8]} | {[1, 1, 3, 2]} | 4 | 1 |
| 302 | {[f1, f2, f3, f8], | {[1, 1, 3, 2], | 4 | 2 |
| | [f1, f2, f4, f8]} | [1, 1, 2, 1]} | | |
| 303 | {[f1, f2, f3], | {[1, 1, 1], | 3 | 2 |
| | [f1, f2, f4]} | [1, 1, 1]} | | |
| 304 | {[f1, f2, f3, f8]} | {[1, 1, 3, 2]} | 4 | 1 |

For example, for the execution case 301, the feature data include a feature data item in the aspect (A), a feature data item in the aspect (B), a feature data item in the aspect (C), and a feature data item in the aspect (D), where: the feature data item in the aspect (A) of the execution case 301 includes an execution order vector [f1,f2,f3,f8] indicating an execution order of f1->f2->f3->f8; the feature data item in the aspect (B) of the execution case 301 includes an execution time vector [1,1,3,2] indicating that the execution times of f1, f2, f3, and f8 associated with the execution case 301 are 1, 1, 3, and 2, respectively; the feature data item in the aspect (C) of the execution case 301 includes a number of 4 indicating that the depth of the spanning tree of the execution case 301 is 4; and the feature data item in the aspect (D) of the execution case 301 includes a number of 1 indicating that the width of the spanning tree of the execution case 301 is 1.

Similarly, for the execution case 302, the feature data include a feature data item in the aspect (A), a feature data item in the aspect (B), a feature data item in the aspect (C), and a feature data item in the aspect (D), where: the feature data item in the aspect (A) of the execution case 302 includes two execution order vectors [f1,f2,f3,f8] and [f1, f2, f4, f8] indicating two execution orders of f1->f2->f3->f8 and f1->f2->f4->f8; the feature data item in the aspect (B) of the execution case 302 includes two execution time vectors [1,1,3,2] and [1,1,2,1] indicating that the execution times of f1, f2, f3, and f8 associated with the execution order f1->f2->f3->f8 are 1, 1, 3, and 2, respectively, and the execution times of f1, f2, f4, and f8 associated with the execution order f1->f2->f4->f8 are 1, 1, 2, and 1, respectively; the feature data item in the aspect (C) of the execution case 302 includes a number of 4 indicating that the depth of the spanning tree of the execution case 302 is 4; and the feature data item in the aspect (D) of the execution case 302 includes a number of 2 indicating that the width of the spanning tree of the execution case 302 is 2.

Further, for network packages, a description of an issue of the software product 105 and one or more files (e.g. one or more logs, one or more development document), any one or more suitable techniques for text processing, such as unsupervised text clustering/probabilistic topic models (e.g. Latent Dirichlet Allocation (LDA) models), classification based on Deep Neural Networks (DNN), Natural Language Processing (NLP), or the like, may be used to extract feature data items in the above example aspects (E), (F) and (G).

For example, for the development document 107 specifying one or more enhanced features of the software product 105, a machine learning model or an artificial intelligence model may be designed and trained to extract one or more features from the development document 107. Further, the machine learning model or the artificial intelligence model may be also designed and trained to associate one or more extracted features with one or more source codes and/or test cases of the software product 105.

For example, NLP and classification based on DNN may be utilized at the same time to analyze one or more logs independently, and a better result may be determined as the feature data in the aspects (F) and/or (G). In another example, feature data items obtained in the example aspects (F) and (G) may be combined together as a whole feature data.

In an embodiment, the part 104 may be trained for example based on a set of historical data associated with the software product 105, so that the part 104 may extract feature data for example at least in one or more of the example aspects (A) to (D) from raw data of text type, such as raw data in the development document 107 and a description of an issue of the software product 105. For example, the feature data extracted during the process of training may be used for build the corpus 101, and in addition or instead, more feature data may be obtained by means of the trained part 104 based on a set of raw data and may be used for build the corpus 101.

As illustrated in FIG. 3B, during the process of training the part 104, for example, one or more legacy development documents 310 and records 311 of source codes associated with the requirements specified in the one or more legacy development documents 310 may be used, which may include descriptions (which may be brief) of source codes of one or more executive units (e.g. methods/functions) associated with respective requirements specified in the one or more development documents 310. For example, the records 311 may be information from logs of source codes version management tools such as SVN (Subversion) and CVS (Concurrent Version System) for maintaining source codes of the software product 105.

One or more keywords or topics associated with respective requirements defined in the one or more legacy development documents 310 may be extracted from the one or more legacy development documents 310 via any one or more suitable manners such as DNN, NLP, or the like. For example, as illustrated in FIG. 3B, a keyword set 312 (also called as information 312), including one or more keywords (e.g. W11, W12, etc.) associated with the requirement RQ1 specified in the one or more legacy development documents 310, one or more keywords (e.g. W21, W22, etc.) associated with the requirement RQ2 specified in the one or more legacy development documents 310, and so on, may be extracted from the one or more legacy development documents 310.

Similarly, one or more keywords or topics associated with respective records in records 311 may also be extracted via any one or more suitable manners such as DNN, NLP, or the like. For example, as illustrated in FIG. 3B, a keyword set 313 (also called as information 313), including one or more keywords (e.g. W11, W12, etc.) associated with the record RD1, one or more keywords (e.g. W21, W22, etc.) associated with the record RD2, and so on, may be extracted from the records 311.

Then, as illustrated in FIG. 3B, a match between the extracted keyword set 312 and keyword set 313 may be performed in an operation 314, for example based on any one or more suitable techniques for text processing, such as unsupervised text clustering/probabilistic topic models (e.g. LDA models), DNN, NLP, or the like, so that information 315 on which executive unit(s) (e.g. functions or methods) in the source codes of the software product 105 are possibly associated with respective requirements specified in the one or more legacy development documents 310 may be obtained. For example, as illustrated in FIG. 3B, in the information 315, it is determined that the requirement RQ1 specified in the one or more legacy development documents 310 may be associated with executive units F1, F3, F4, and so on; the requirement RQ2 specified in the one or more legacy development documents 310 may be associated with executive units F2, F5, F6, and so on; or the like.

Further, as illustrated in FIG. 3B, one or more execution cases (e.g. test cases) 316 associated with respective executive units may be obtained, for example from the corpus 101 or another database or file system storing the information on the one or more execution cases. In an embodiments, the corpus 101 may be trained in advance to allow an optimized selection of execution cases (see details below).

Based on the information 315 and the one or more execution cases 316, for example through an operation 317 as illustrated in FIG. 3B, respective requirements specified in the one or more legacy development document 310 may be associated with one or more execution cases, and thus information 318 on such association between respective requirements and one or more execution cases may be obtained. For example, as illustrated in FIG. 3B, according to the information 318, the requirement RQ1 may be associated with the execution cases TC1, TC3, and so on, and the requirement RQ2 may be associated with the execution cases TC2, TC4, and so on.

Further, as illustrated in FIG. 3B, for example in an operation 319, for example historical software runtime footprint tree data or one or more other logs of the software product 105 may be utilized to obtain feature data for example at least in one or more of the example aspects (A) to (D) based on the information 315 and 318, which procedure may be similar to the example as illustrated in FIG. 3A. For example, as illustrated in information 320 in FIG. 3B, for the requirement RQ1, a feature data in the aspect (A) may include an execution order vector [F1, F2, F4, F7 . . . ], and so on.

Further, as illustrated in FIG. 3B, a set of rules 321 for automatic code generation may be predetermined. Then, in an operation 322, the predetermined rules 312 may be utilized to determine one or more recommendations 323 on automatic code generation for respective requirements, for example based on at least one of the information 315 and 312. For example, as illustrated in FIG. 3B, for the requirement RQ1, automatic code generation recommendations AUTO11, AUTO12, and so on may be generated in the operation 322, where, for example, the recommendation item AUTO11 may be related to the execution unit F2, AUTO12 may be related to the execution unit F7, and so on. In various embodiments, any one or more suitable manners may be used in the operation 322. For example, the operation 322 may be implemented based on one or more of a machine learning (ML) model, a convolutional neural network (CNN), and so on.

Further, during the above process in FIG. 3B, one or more sets of true values or reference data (which may be determined in advance for example based on experiences) may be used for adjusting parameters of the models (e.g. DNN, NLP model, ML model, CNN, and so on) for obtaining information 312 from the one or more legacy development document 310, for obtaining information 313 from the recodes 311, for implementing the operation 314, and for implementing the operation 322. For example, the part 104 may be trained iteratively, for example by adjusting iteratively parameters of respective used models, so that deviations between respective information and corresponding true values may be below respective predetermined thresholds. For example, the parameters of the DNN, NLP, or the like used to obtaining the information 312 from the one or more legacy development document 310 may be adjusted iteratively during the process of feature extraction based on the one or more legacy development document 310, so that, for example, a deviation between the information 312 obtained after a number of iterative adjustments of the parameters of the DNN, NLP, or the like and a corresponding set of true values may be below an expected threshold or begin to converge. Similarly, for example, in the operation 322, the parameters of the used model may be adjusted iteratively so that, for example, a deviation between the information 312 obtained after a number of iterative adjustments of the parameters of the used model and a corresponding set of true values may be below an expected threshold or begin to converge.

In another embodiment, for example, more legacy development document and corresponding records of related source codes may be involved in the training process as illustrated in FIG. 3B.

Further, at least one of information 312, 313, 315, 318, 320, and 323 may be used to build the corpus 101. For example, the information 313 including keyword set extracted from the records 311 may be stored into the corpus 101, so that the information 313 may be retrieved from the corpus 101 and used during later processes such as providing recommendations and adjusting (e.g. adding new data) the corpus 101.

After the part 104 is trained, for example after deviations between respective outputs of the part 104 and respective true values satisfy corresponding threshold conditions, the part 104 may be used to extract feature data based on more raw data, for example either for enabling the corpus 101 to include more feature data, or for providing actual recommendations.

For example, as illustrated in FIG. 3C, for the development document 107 which may specify one or more new requirements such as NRQ1, NRQ2, NRQ3, and so on, the trained part 104 may parse the development document 107 to obtain a keyword set 324 which may include one or more keywords associated with respective new requirements. In addition, the trained part 104 may also extract the keyword set 313 for example from the corpus 101.

Then, in the operation 314, a match between the extracted keyword set 324 and the keyword set 313 may be performed in the operation 314, so as to obtain information 325 on which executive unit(s) (e.g. functions or methods) in the source codes of the software product 105 are possibly associated with respective new requirements specified in the development documents 107.

Further, as illustrated in FIG. 3C, one or more execution cases (e.g. test cases) 316 associated with respective executive units included in the information 325 may be obtained, for example from the corpus 101 or another database or file system storing the information on the one or more execution cases. In an embodiment, the corpus 101 may be trained in advance to allow an optimized selection of execution cases (see details below).

Then, as illustrated in FIG. 3C, based on the information 325 and the one or more execution cases 316, for example through the operation 317, respective new requirements specified in the development document 107 may be associated with one or more execution cases, and thus information 326 on such association between respective new requirements and one or more execution cases may be obtained.

Further, as illustrated in FIG. 3C, in the operation 319, for example historical software runtime footprint tree data or one or more other logs of the software product 105 may be utilized to obtain feature data for example at least in one or more of the example aspects (A) to (D) based on the information 325 and 326, which procedure may be similar to the example as illustrated in FIG. 3A. For example, as illustrated in information 327 in FIG. 3C, for the new requirement NRQ1, a feature data in the aspect (A) may include an execution order vector [F1, F2, F4, F7, . . . ], and so on.

Further, as illustrated in FIG. 3C, in an operation 322, the predetermined rules 312 may be utilized to determine one or more recommendations 323 on automatic code generation for respective new requirements, for example based on at least one of the information 325 and 327. For example, as illustrated in FIG. 3C, for the new requirement NRQ1, automatic code generation recommendations AUTO11, AUTO12, and so on may be generated in the operation 322, where, for example, the recommendation item AUTO11 may be related to the execution unit F2, AUTO12 may be related to the execution unit F7, and so on.

Further, as illustrated in FIG. 3C, at least one of information 325, 326, 327, and 328 may be used to build the corpus 101, for example to expand data in the corpus 101.

In another embodiment, for example as illustrated by the bold arrow from the corpus 101 to the operation 314, information such as information 316 may also be obtained in the operation 314 from the corpus 101 and used in the operation 314. Further, one or more of the operations 317, 319, and 322 may also be implemented or merged into the operation 314, so that at least one of the information 327 and 328 may be obtained in the operation 314.

In addition, the example procedure as illustrated in FIG. 3C may be also an example of feature extraction during the procedure of providing recommendation, for example for a development of the software product 105, where, for example, information on at least one of information 325, 326, 327, and 328 may be included in the one or more recommendation items 109 as illustrated in FIG. 1. For example, for the development document 107, information 324 including keyword set of the development document 107 may be obtained, and then the operation 314 may be performed to obtain at least one of the information 327 and 328. In a case of failed to obtain at least one of the information 327 and 328 in the operation 314, for example, the part 104 may obtain the information 325 through the operation 314, and then perform one or more of the operations 317, 319, and 322, so as to generate the recommendation items.

It is appreciated that the similarity considerations, the forms/formats of respective extracted feature data items, and the manners of extracting feature data items in respective similarity considerations are not limited to the above examples. For example, for the feature items in the aspects (A) and (B), for convenience of similarity calculations, the execution order vectors and the execution time vectors of an execution case may be expressed in a form considering a union of executable units of all execution cases. For example, for the execution cases 301, 302, 303, and 304 as illustrated in FIG. 3A, assuming that a union of executable units of a plurality of execution cases including the above example execution cases 301, 302, 303, and 304 is {f1,f2,f3,f4,f8}, then the execution order vectors of the execution cases 301, 302, 303, and 304 listed in Table 1 may be rewritten as {[1,1,1,0,1] }, {[1,1,1,0,1],[1,1,0,1,1]}, {[1,1,1,0,0], [1,1,0,1,0]}, and {[1,1,1,0,1]}, respectively, where “1” represents including an executable unit in the union, and “0” represents not including an executable unit in the union; and the execution time vectors of the execution cases 301, 302, 303, and 304 in Table 1 may be rewritten as {[1,1,3,0,2]}, {[1,1,3,0,2], [1,1,0,2,1]}, {[1,1,1,0,0], [1,1,0,1,0]}, and {[1,1,3,0,2]}, respectively, where each element in an execution time vector represents the execution time of the corresponding executable unit in the union.

Then, the corpus 101 may be built based on the feature data set extracted by the part 104.

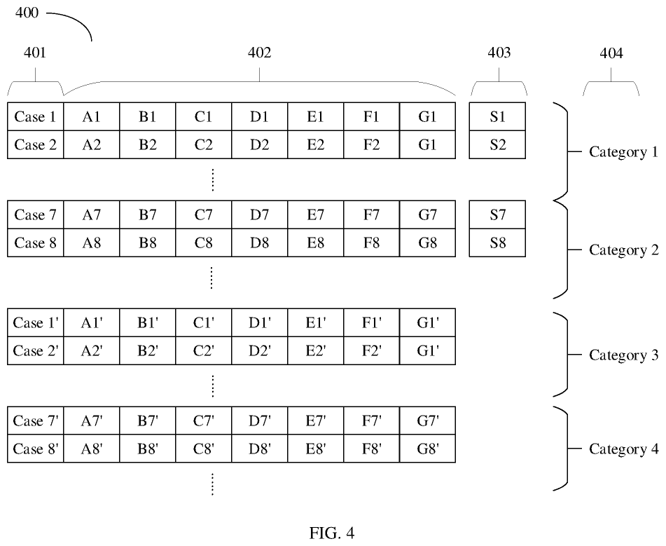

As illustrated in FIG. 4, the corpus 101 may include a set of data items 400 where each data item (each row in the FIG. 4) may include information 401 (e.g. an identity) on the corresponding execution case (e.g. a test case), and feature data items 402 of the corresponding execution case for example in the above example aspects (A)-(G). For example, for the row of “Case 1” in FIG. 4, A1 to G1 represent feature data items of Case 1 in the aspect (A)-(G), respectively.

For example, the feature data of an abnormal execution case (e.g. corresponding to an issue) may also include a data item 403 for recording a solution for the corresponding abnormal execution case. For example, for the abnormal execution case “Case 1” as illustrated in FIG. 4, an additional data item S1 is also included in the feature data, which is information on a solution for the abnormal “Case 1”. Similarly, additional data items S2, S7, and S8 are also included in respective feature data of the abnormal cases “Case 2”, “Case 7”, and “Case 8”, respectively. As illustrated in FIG. 4, the additional data items for solution may be not provided for those normal execution cases such as “Case 1′”, “Case 2′”, “Case 7′”, and “Case 8′” as illustrated in FIG. 4.

Further, the feature data set in the corpus 101 may be categorized or classified into one or more classes or categories. For example, in the example of FIG. 4, cases including “Case 1”, “Case 2”, and so on are categorized into a “Category 1”, cases including “Case 7”, “Case 8”, and so on are categorized into a “Category 2”, cases including “Case 1′”, “Case 2′”, and so on are categorized into a “Category 3”, cases including “Case 7′”, “Case 8′”, and so on are categorized into a “Category 5”. In an embodiment, the information on categories 404 of respective cases may be also included in the corpus 101. Accordingly, in an embodiment, the part 104 may also be configured to determine a category for an execution case of the software product 105, for example based on one or more extracted feature items in one or more similarity considerations. For example, in the example of FIG. 4, the categories 404 may be determined based on respective feature data items in the aspect (A) or accuracy. In various embodiments, one or more classifiers may be configured in the part 104 for the classification, which may include, but are not limited to, one or more of supervised classifiers, semi-supervised classifiers, or unsupervised classifiers, for example one or more of: a multivariate linear regression model classifier; an association analysis classifier; a Bayesian classifier; a support vector machine (SVM) classifier; or the like.

Further, for any pair of feature data in the corpus 101, one or more similarity values indicating similarities may be determined between the pair of feature data in terms of one or more similarity considerations including the above aspects (A) to (G), respectively, and then a unified similarity factor indicating a final similarity between the pair of feature data may be determined based on a multiple linear regression, which may be used later in the part 102 for providing recommendation.

For example, for any two execution cases C₁ and C₂, where the feature items of the execution case C₁ in the aspects (A)-(G) are A₁, B₁, C₁, D₁, E₁, F₁, and G₁, respectively, and the feature items of the execution case C₂ in the aspects (A)-(G) are A₂, B₂, C₂, D₂, E₂, F₂, and G₂, respectively, a similarity value SA₁₂ between A₁ and A₂, a similarity value SB₁₂ between B₁ and B₂, a similarity value SC₁₂ between C₁ and C₂, a similarity value SD₁₂ between D₁ and D₂, a similarity value SE₁₂ between E₁ and E₂, a similarity value SF₁₂ between F₁ and F₂, and a similarity value SG₁₂ between G₁ and G₂ may be determined. Then, a unified similarity factor USF₁₂=b₀+b₁SA₁₂+b₂SB₁₂+b₃SC₁₂+b₄SD₁₂+b₅SE₁₂+b₆SF₁₂+b₇SG₁₂ may be determined, for example based on a multivariate linear regression, where b₀+b₁+b₂+b₃+b₄+b₅+b₆+b₇=1.

When calculating SA₁₂, any suitable manner for determining a similarity between two vectors may be adopted. Due to possibly different branches of different execution cases, a sum of similarities of different branches may be obtained, and an average over the different branches may be obtained as SA₁₂.

For example, in a case of calculating similarity of a branch by cosine similarity, assuming that A₁={O₁₁, O₁₂, . . . , O₁ₘ} (m is an integer larger than 0) and B₂={O₂₁, O₂₂, . . . , O₂ₙ} (n is an integer larger than 0) where O₁ᵢ (0<i<m+1) is an i-th operation order vector in A₁ and O₂ⱼ (0<j<n+1) is an j-th operation order vector in A₂, then the similarity value SA₁₂ may be determined based on the following formula:

$${SA}_{12} = {\sum }_{i = 1}^{m} {\sum }_{j = 1}^{n} \frac{\frac{{O}_{1 i} * {O}_{2 j}}{‖ {O}_{1 i} ‖ ‖ {O}_{2 j} ‖}}{m * n} \qquad ( 1 )$$

Similarly, for example, assuming that B₁={T₁₁, T₁₂, . . . , T₁ₘ} (m is an integer larger than 0) and B₂={T₂₁, T₂₂, . . . , T₂ₙ} (n is an integer larger than 0) where T₁ᵢ (0<i<m+1) is an i-th operation time vector in B₁ and T₂ⱼ (0<j<n+1) is an j-th operation time vector in B₂, the similarity value SB₁₂ may be determined based on the following formula:

$${SB}_{12} = {\sum }_{i = 1}^{m} {\sum }_{j = 1}^{n} \frac{\frac{{T}_{1 i} * {T}_{2 j}}{‖ {T}_{1 i} ‖ ‖ {T}_{2 j} ‖}}{m * n} \qquad ( 2 )$$

It is appreciated that the manner of calculating similarity of a branch is not limited to the cosine similarity, but instead, any suitable manner of calculating similarity between two vectors may be adopted.

Further, the similarity values SC₁₂ in the aspect (C) may be determined based on the following formula:

$${SC}_{12} = \{ \begin{matrix}1 , & if {C}_{1} = {C}_{2} \\ 0 , & if {C}_{1} \neq {C}_{2}\end{matrix} \qquad ( 3 )$$

Similarly, the similarity values SD₁₂ in the aspect (D) may be determined based on the following formula:

$${SD}_{12} = \{ \begin{matrix}1 , & if {D}_{1} = {D}_{2} \\ 0 , & if {D}_{1} \neq {D}_{2}\end{matrix} \qquad ( 3 )$$

For the examples as illustrated in FIG. 3A, similarity values between two execution cases in respective aspects of (A), (B), (C), and (D) may be listed in the following Table 2.

TABLE 2

| | Similarity | Similarity | Similarity | Similarity |
|---|---|---|---|---|
| Case Pair | in (A) | in (B) | in (C) | in (D) |
| 301 and 302 | 0.875 | 0.6424 | 1 | 0 |
| 301 and 303 | 0.6866 | 0.5217 | 0 | 0 |
| 301 and 304 | 1 | 1 | 1 | 1 |
| 302 and 303 | 0.7217 | 0.494 | 0 | 1 |
| 302 and 304 | 0.875 | 0.6424 | 1 | 0 |
| 303 and 304 | 0.6866 | 0.5217 | 0 | 0 |

Further, the similarity value SE₁₂ between E₁ and E₂, the similarity value SF₁₂ between F₁ and F₂, and the similarity value SG₁₂ between G₁ and G₂ may be determined in one or more suitable manners.

For example, for one or more network packages of an execution case of the software product 105, a correlation coefficient (e.g. Jaccard coefficient) between E₁ and E₂ may be determined as the similarity value SE₁₂ for measuring similarity between network packages of two execution cases C₁ and C₂. In an embodiment, for an execution case in the aspect (E), a keyword vector including one or more keywords and a value vector including one or more values corresponding to the one or more keywords in the keyword vector may be extracted from one or more network packages associated with software product 105. Then, for the two execution cases C₁ and C₂, assuming that E₁ includes a keyword vector W1=[W11, W₁₂, . . . , W₁ₖ] and corresponding value vector V₁=[V₁₁, V₁₂, . . . , V₁ₖ], and E₂ includes a keyword vector W₂=[W₂₁, W₂₂, . . . , W₂ₖ] and corresponding value vector is V₂=[V₂₁, V₂₂, . . . , V₂ₖ], then a similarity vector SV₁₂=[SV₁, SV₂, . . . , SVₖ] may be determined where SVᵢ=1 (i is an integer larger than 0) if W₁ᵢ=W₂ᵢ and V₁ᵢ=SV₂ᵢ, SVᵢ=0.5 if W₁ᵢ=W₂ᵢ and V₁ᵢ≠V₂ᵢ, and SVᵢ=0 if W₁ᵢ≠W₂ᵢ. Then, a similarity value SE₁₂ may be determined based on the following formula:

SE₁₂=(Σᵢ₌₁^{k}SVᵢ)/k (4)

For a description of an issue of the software product 105 and one or more files (e.g. one or more logs, one or more development document), any one or more suitable manners, such as unsupervised text clustering/probabilistic topic models (e.g. LDA models), classification based on Deep Neural Networks (DNN), Natural Language Processing (NLP), or the like, may be used to extract feature data items in the above example aspects (F) and/or (G). Further, semantic similarity may be measured between two issue descriptions and/or files based on such one or more models, and correlation and complexity between two topics may also be obtained based on such one or more models, based on which the similarity values SF₁₂ and SG₁₂ may be determined.

After determining the similarity values SA₁₂, SB₁₂, SC₁₂, SD₁₂, SE₁₂, SF₁₂, SG₁₂ or the like for the execution cases C₁ and C₂, a unified similarity factor USF₁₂=b₀+b₁SA₁₂+b₂SB₁₂+b₃SC₁₂+b₄SD₁₂+b₅SE₁₂+b₆SF₁₂+b₇SG₁₂ may be determined, for example based on a multivariate linear regression. Then, a training may be performed based on the data in the corpus 101 to obtain the weights b₁, b₂, b₃, b₄, b₅, b₆, b₇.

An example of training based on the multivariate linear regression will be described now. Assuming that the execution cases in the corpus 101 are indexed with 1, 2, 3, . . . , m (m is an integer larger than 0), then for any two cases Ci and Cj (i and j are different integers in the range from 1 to m), initial values of weights b₁, b₂, b₃, b₄, b₅, b₆, b₇ may be used to estimate a unified similarity factor (USF). Then, the weights b₁, b₂, b₃, b₄, b₅, b₆, b₇ may be adjusted, for example, iteratively, so that a deviation between the estimated USF and a corresponding reference USF is below a predetermined threshold, for example so that a square sum of the deviations is below the predetermined threshold (for example, sum of the deviations is minimized or converges), as follows.

Σᵢ₌₁^{m}Σⱼ₌₁ⁿ(yᵢⱼ− [symbol] )²=Σᵢ₌₁^{m}Σⱼ₌₁ⁿ(yᵢⱼ−bX^{ij})²<threshold (5)

where yᵢⱼ is a reference USF (e.g. an experimental USF) for the cases Cᵢ and Cⱼ, [symbol] is an estimated USF for the cases Cᵢ and Cⱼ, b=[b₀, b₁, b₂, b₃, b₄, b₅, b₆, b₇]^{T}, X^{ij} represents [1, SAᵢⱼ, SBᵢⱼ, SCᵢⱼ, SDᵢⱼ, SEᵢⱼ, SFᵢⱼ, SGᵢⱼ] in the follow matrix X,

$$X = [ \begin{matrix}1 , 1 , 1 , 1 , 1 , 1 , 1 , 1 \\ 1 , {SA}_{12} , {SB}_{12} , {SC}_{12} , {SD}_{12} , {SE}_{12} , {SF}_{12} , {SG}_{12} \\ 1 , {SA}_{13} , {SB}_{13} , {SC}_{13} , {SD}_{13} , {SE}_{13} , {SF}_{13} , {SG}_{13} \\ … \\ 1 , {SA}_{ij} , {SB}_{ij} , {SC}_{ij} , {SD}_{ij} , {SE}_{ij} , {SF}_{ij} , {SG}_{ij} , \\ … \\ 1 , {SA}_{m - 1 , m} , {SB}_{m - 1 , m} , {SC}_{m - 1 , m} , {SD}_{m - 1 , m} , {SE}_{m - 1 , m} , {SF}_{m - 1 , m} , {SG}_{m - 1 , m}\end{matrix} ]$$

where SAᵢⱼ, SBᵢⱼ, SCᵢⱼ, SDᵢⱼ, SEᵢⱼ, SFᵢⱼ, SGᵢⱼ represents similarity values between the feature data of the cases Cᵢ and Cⱼ in aspects (A)-(G), respectively.

By solving the linear regression equation Y=bX through least square method, according to the determined regression parameters and the extremum principle, the matrix value of b may be determined as b=(X^{T}X)⁻¹X^{T}Y, where Y=[y₁₁, y₁₂, y₁₃, . . . , yᵢⱼ, . . . y_{m-1,m}]^{T}. Then, the estimated USF for the two cases Cᵢ and C^{j} may be determined based on the calculation [1, SAᵢⱼ, SBᵢⱼ, SCᵢⱼ, SDᵢⱼ, SEᵢⱼ, SFᵢⱼ, SGᵢⱼ] (X^{T}X)₋₁x^{T}Y.

It is appreciated that the example training process may be modified to apply to training fewer or more weights, for example for training b₁, b₂, b₆ in a case where the aspects (A), (B), (F) are considered and the unified similarity factor is determined based on USF₁₂=b₀+b₁SA₁₂+b₂SB₁₂+b₆SF₁₂, or for training the weights b₁ and b₈ in case where another similarity consideration aspect H different from the above aspects (A)-(G) is considered and the unified similarity factor is determined based on USF₁₂=b₀+b₁SA₁₂+b₈SH₁₂, where SH₁₂ may indicates a similarity value between the feature data of the two cases C₁ and C₂ in the aspect H.

Further, it is appreciated that any other suitable manners may be adopted for training the above one or more weights and/or calculating the USF based on the one or more trained weights, in addition to or in lieu of the multivariate linear regression.

The trained weights may be included in the corpus 101. In some embodiments, the trained weights may be different for different categories and/or different execution case suite (e.g. test case suite).

Based on the built and trained corpus 101, recommendations may be provided for example in the part 102 of the example solution 100.

For example, in a case where the part 103 captures an issue from the software product 105, the example solution 100 may extract feature data in one or more similarity considerations. For example, a category of the issue may be determined based on one or more classifiers (e.g. one or more of supervised classifiers, semi-supervised classifiers, or unsupervised classifiers) in the part 104 based on the extracted feature or raw data captured in the part 103. Then, the part 102 may search the corpus 101 based on the category and the extracted feature data for a piece of feature data similar or substantially the same with the extracted feature data (e.g. the USF between the two feature data is above a predetermined threshold). If find such a feature data in the corpus 101, the part 102 may generate a recommendation based on the solution item associated with the found feature data. Further, for example, the part 102 may also trigger the test executor 106 to run one or more test cases associated with the feature data found in the corpus 101. Further, for example, the part 102 may add the extracted feature data and associated solution into the corpus 101.

For example, in a case where the part 102 gets category information in the corpus 101 for the extracted feature data but fails to find a feature data in the corpus 101 which has a USF above the predetermined threshold with the extracted feature, the part 102 may search the corpus 101 for one or more feature data which have USF above another threshold lower than the predetermined threshold, for example in the aspects (A), (F) and (G). Then, the part 102 may generate a recommendation based on the solution items associated with the one or more found feature data in the corpus 101. Further, for example, the part 102 may also trigger the test executor 106 to run one or more test cases associated with the one or more feature data found in the corpus 101.

For example, in a case where the part 102 fails to get category information in the corpus 101 for the extracted feature data, the part 102 may generate a recommendation including information on failed functions/methods of the software product 105, related files, and network packages, similar symptoms, and so on.

For example, in a case no feature data is found in the corpus 101 which has a USF above a predetermined threshold with the extracted feature data, the corpus 101 may be updated for example by adding more sample data and the weights for estimating the USF may be adjusted accordingly.

For example, in a case of adding new functions to the software product 105, the part 104 may extract features by performing text mining on the development document 107. Then, the part 102 may search the corpus 101 based on the extracted features for current code logic and related existing test cases. After obtaining the regular code, the part 102 may add the item in the code auto generation part, and output related information. When the feature requirement specification call flow is extracted, the call flow related code changes may be attached in the recommended solution area. An example of feature extraction from the development document 107 may also be seen in FIG. 3C. Thus, an intelligent product code logic enhancement and automatic generation of code based on different regular templates may be achieved, so that redundant software product code and repetitive work in different products may be avoided, and the efficiency of development and test may be improved for example due to fast location of codes and test cases.

For example, in a case of test, the part 102 may search the corpus 101 for one or more test cases based on information from the input 108 (e.g. information code coverage), and one or more test cases may be selected so that a USF between any two of the selected test cases is below a predetermined threshold. Thus, more diverse of test cases may be selected and duplicated test cases may be removed or partially merged, so that an optimized selection of execution cases with higher speed and efficiency may be implemented.

For example, for the example of FIG. 3A and Table 2, if considering the aspects (A) to (D) and using weight matrix b=[0.057, 0.72, 0.123, 0.053, 0.047]^{T} (which has been trained based on 1000 test cases in advance) for calculating USF, then respective USF of respective case pairs may be as the following Table 3.

TABLE 3

| | Similarity | Similarity | Similarity | Similarity | |
|---|---|---|---|---|---|
| Case Pair | in (A) | in (B) | in (C) | in (D) | USF |
| 301 and 302 | 0.875 | 0.6424 | 1 | 0 | 0.819 |
| 301 and 303 | 0.6866 | 0.5217 | 0 | 0 | 0.6155 |
| 301 and 304 | 1 | 1 | 1 | 1 | 1 |
| 302 and 303 | 0.7217 | 0.494 | 0 | 1 | 0.6844 |
| 302 and 304 | 0.875 | 0.6424 | 1 | 0 | 0.819 |
| 303 and 304 | 0.6866 | 0.5217 | 0 | 0 | 0.6155 |

From the Table 3, it can be seen that the estimated USF in the embodiments may reflect the execution case similarity well. For example, for the two cases 301 and 304 which substantially the same in aspects (A) to (D), the estimated USF is 1 meaning that the two cases match with each other. For the two cases 301 and 302, the case 301 is actually a subset of the case 302, and thus they have a higher similarity, with the value of the estimated USF being 0.819. Thus, when selecting test cases, for example, the test cases 302 and 303 may be recommended, and the test cases 301 and 304 may be ignored. Thus, for example, overall execution time may be reduced by removing or merging the duplicated test cases

It is appreciated that this disclosure is not limited to the above example embodiments. One or more modifications, additions, deletions may be made based on the above examples. For example, as illustrated in Table 3, training weights for respective similarity considerations and calculating USF based on the trained weight by means of a multiple linear regression may ensure accuracy and reliability of the finally calculated USF. However, in another embodiment, any other suitable manners may be adopted for training weights for respective similarity considerations and calculating USF based on the trained weight.

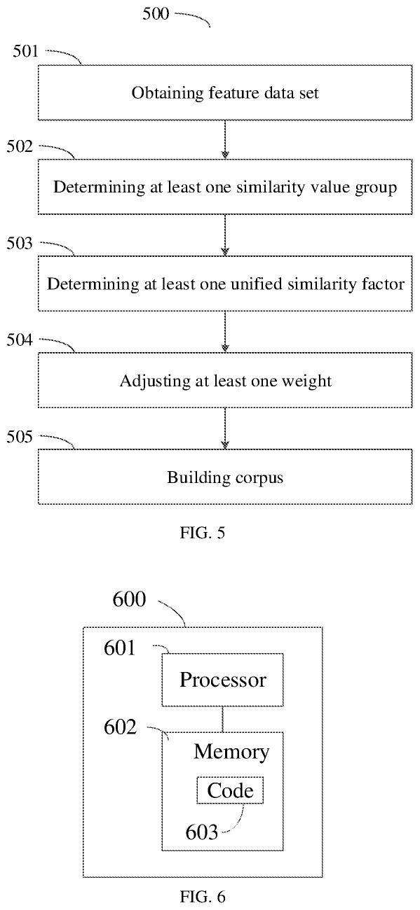

FIG. 5 illustrates an example method 500 for building corpus (e.g. the above corpus 101) for solution recommendation a software product (e.g. the above software product 105) in an embodiment. As illustrated in FIG. 5, the example method 500 may include operations 501, 502, 503, 504, and 505.

In the operation 501, a feature data set corresponding to a raw data set associated with a software product may be obtained, where respective piece of feature data in the feature data set may include at least one feature data item in terms of at least one similarity consideration for raw data in the raw data set, for example in terms of one or more of the above aspects (A) to (G). For example, the operation 501 may be performed in the part 104 in the example solution 100 based on the raw data set obtained by the part 103.

Then, in the operation 502, at least one similarity value group (e.g. the matrix X in the above examples) may be determined for the feature data set determined in the operation 501, where respective similarity value group (e.g. a row in the matrix X) may include at least one similarity value between at least one feature data item in first feature data in the feature data set and at least one feature data item in second feature data in the feature data set (e.g. SAᵢⱼ, SBᵢⱼ, SCᵢⱼ, SDᵢⱼ, SEᵢⱼ, SFᵢⱼ, SGᵢⱼ, in the above examples).

Then, in the operation 503, at least one unified similarity factor (e.g. ŷᵢⱼ in the above examples) may be determined with at least one weight (e.g. b₁, b₂, b₃, b₄, b₅, b₆, b₇ in the above examples) for the at least one similarity consideration to the at least one similarity value group. For example, a multivariate linear regression with the at least one weight may be used to obtain the at least one similarity factor.

Then, in the operation 504, the at least one weight may be adjusted so that a deviation between the at least one unified similarity factor and at least one reference unified similarity factor is below a predetermined threshold.

Then, in the operation 505, the corpus (e.g. the corpus 101 in the above examples) may be built. In some embodiments, the corpus may include information on the feature data set obtained in the operation 501 and/or the at least one weight trained/adjusted in the operation 504.

In some embodiments, the at least one similarity consideration may include at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

In some embodiments, the example method 500 may further include determining at least one category for the feature data set as illustrated in FIG. 4.

In some embodiments, the raw data in the raw data set may include at least one of: runtime data associated with the software product, software runtime footprint tree data associated with the software product, historical data associated with the software product, an issue description associated with the software product, at least one network package associated with the software product, at least one log associated with the software product, at least one source code associated with the software product, at least one test case associated with the software product, at least one file associated with the software product, at least one develop document associated with the software product, and at least one solution collection associated with the software product.

In some embodiments, the example method 500 may further include associating at least one feature data in the feature data set with at least one of at least one software code of the software product or at least one test case of the software product.

In some embodiments, the example method 500 may further include extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature.

In some embodiments, the example method 500 may further include determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit.

In some embodiments, the example method 500 may further include determining at least one automatic code generation recommendation for respective requirement based on the at least one feature data items of respective requirement.

In some embodiments, the example method 500 may further include monitoring the software product to obtain the raw data set associated with software product at runtime.

FIG. 6 illustrates an example apparatus 600 for building corpus (e.g. the above corpus 101) for solution recommendation a software product (e.g. the above software product 105) in an embodiment.

As shown in FIG. 6, the example apparatus 600 may include at least one processor 601 and at least one memory 602 that may include computer program code 603. The at least one memory 602 and the computer program code 603 may be configured to, with the at least one processor 601, cause the apparatus 600 at least to perform at least the operations of the example method 500 described above.

In various embodiments, the at least one processor 601 in the example apparatus 600 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 601 may also include at least one other circuitry or element not shown in FIG. 6.

In various embodiments, the at least one memory 602 in the example apparatus 600 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 602 may include, but are not limited to, an electric, a magnetic, an optical, an electromagnetic, an infrared, or a semiconductor system, apparatus, or device or any combination of the above.

Further, in various embodiments, the example apparatus 600 may also include at least one other circuitry, element, and interface, for example at least one I/O interface, at least one antenna element, and the like.

In various embodiments, the circuitries, parts, elements, and interfaces in the example apparatus 600, including the at least one processor 501 and the at least one memory 602, may be coupled together via any suitable connections including, but not limited to, buses, crossbars, wiring and/or wireless lines, in any suitable ways, for example electrically, magnetically, optically, electromagnetically, and the like.

FIG. 7 illustrates an example apparatus 700 for building corpus (e.g. the above corpus 101) for solution recommendation a software product (e.g. the above software product 105) in an embodiment.

As shown in FIG. 7, the example apparatus 700 may include means for performing operations of the example method 600 described above in various embodiments. For example, the apparatus 700 may include means 701 for performing the operation 501 of the example method 500, means 702 for performing the operation 502 of the example method 500, means 703 for performing the operation 503 of the example method 500, means 704 for performing the operation 504 of the example method 500, and means 705 for performing the operation 505 of the example method 500. In one or more another embodiment, at least one I/O interface, at least one antenna element, and the like may also be included in the example apparatus 700.

In some embodiments, examples of means in the apparatus 700 may include circuitries. In some embodiments, examples of means may also include software modules and any other suitable function entities. In some embodiments, one or more additional means may be included in the apparatus 700 for performing one or more additional operations of the example method 500.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

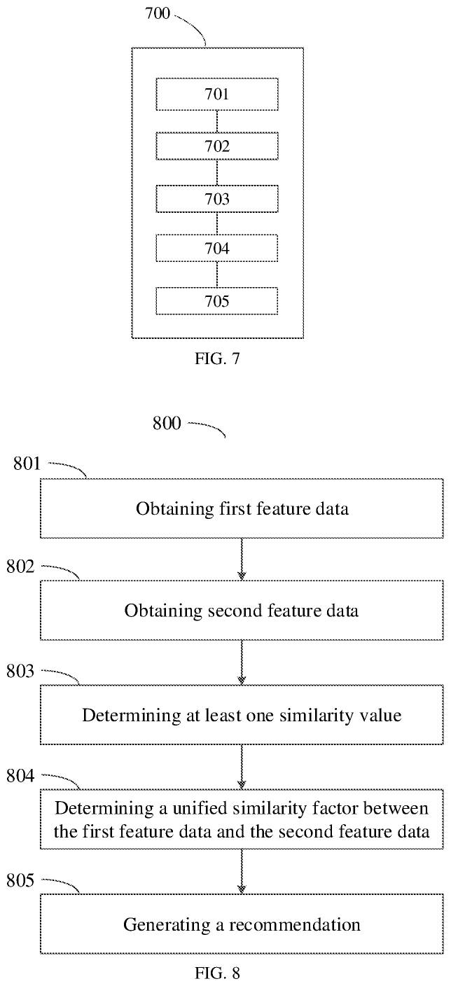

FIG. 8 illustrates an example method 800 for solution recommendation a software product (e.g. the above software product 105) in an embodiment, which may include operations 801, 802, 803, 804, and 805.

In the operation 801, first feature data including at least one first feature data item in terms of at least one similarity consideration (e.g. the above aspect (A) to (G)) for raw data associated with a software product (e.g. the above software product 105) may be obtained. For example in a case of providing recommendation on test cases for the software product, the first feature data may be obtained from the corpus (e.g. the corpus 101). For example in a case of providing recommendation on an issue of the software product or a development of the software product, the first feature data may be extracted from the raw data such as issue description of the software product or related logs/files/documents (e.g. the development document 107) of the software product.

Then, in the operation 802, second feature data may be obtained from the corpus associated with the software product, where the second feature data may include at least one second feature data item in terms of the at least one similarity consideration.

Then, in the operation 803, at least one similarity value between the at least one first feature item and at least one second feature item may be determined, and in the operation 804, a unified similarity factor between the first feature data and the second feature data may be determined with at least one weight for the at least one similarity consideration to the at least one similarity value. For example, the manners of determining similarity values and calculating USF are substantially the same for the training phase of the corpus 101 and the practical application phase of the example solution 100. For example, a multivariate linear regression with the at least one weight may be applied to obtain the unified similarity.

Then, in the operation 805, a recommendation on the software product may be generated based on the unified similarity factor. In some embodiments, the recommendation may include at least one of: selecting at least one test case associated with the first feature data and at least one test case associated with the second feature data in a case where the unified similarity factor is below the predetermined threshold; providing at least one of at least one recommendation item associated with the second feature data, at least one source code of the software product associated with the second feature data, or at least one test case of the software product associated with the second feature data, in a case where the unified similarity factor is above the predetermined threshold; re-executing the software product with at least one recommended configuration parameter associated with the second feature data in a case where the unified similarity factor is above the predetermined threshold; or executing a set of test cases associated with the software product. For example, the recommendations may be performed automatically.

In some embodiments, the example method 800 may further include determining a category of the first data to obtain the second data from the corpus based on the category. In some embodiments, the solution recommendation may be generated based on at least one of the category or at least one feature data in the corpus in case where the unified similarity factor is below a predetermined threshold, where the at least one feature data belongs to the category and at least one unified similarity factor between the at least one feature data and the first feature data being above another predetermined threshold.

In some embodiments, the example method 800 may further include obtaining the raw data associated with the software product and obtaining the first feature data based on the raw data, where the raw data may include at least one of: runtime data associated with the software product, software runtime footprint tree data associated with the software product, historical data associated with the software product, an issue description associated with the software product, at least one network package associated with the software product, at least one log associated with the software product, at least one code associated with the software product, at least one test case associated with the software product, at least one file associated with the software product, at least one develop document associated with the software product, and at least one solution collection associated with the software product.

In some embodiments, the example method 800 may further include associating the first feature data with at least one of at least one software code or at least one test case associated with the software product.

In some embodiments, the example method 800 may further include extracting at least one first feature of at least one requirement from at least one file or description associated with the software product, extracting at least one second feature from at least one historical records associated the source codes of the software product, and associating respective requirement of the at least one requirement with at least one executive unit based on the at least one first feature and the at least one second feature.

In some embodiments, the example method 800 may further include determining at least one execution case associated with the at least one executive unit, and determining at least one feature data items of respective requirement in at least one of the execution order of the at least one executable unit, the execution number of the at least one executable unit, the execution depth of the at least one executable unit, and the execution width of the at least one executable unit, based on the at least one execution case and the association of the respective requirement of the at least one requirement with the at least one executive unit.

In some embodiments, the example method 800 may further include determining at least one automatic code generation recommendation for respective requirement based on the at least one feature data items of respective requirement.

In some embodiments, the example method 800 may further include monitoring the software product to obtain the raw data corresponding to the first feature data at runtime.

In some embodiments, the example method 800 may further include adjusting the at least one weight in a case where unified similarity factors between one or more feature data in the corpus and the first feature data are below a predetermined threshold.

FIG. 9 illustrates an example apparatus 900 for solution recommendation a software product (e.g. the above software product 105) in an embodiment.

As shown in FIG. 9, the example apparatus 900 may include at least one processor 901 and at least one memory 902 that may include computer program code 903. The at least one memory 902 and the computer program code 903 may be configured to, with the at least one processor 901, cause the apparatus 900 at least to perform at least the operations of the example method 800 described above.

In various embodiments, the at least one processor 901 in the example apparatus 900 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 901 may also include at least one other circuitry or element not shown in FIG. 9.

In various embodiments, the at least one memory 902 in the example apparatus 900 may include at least one storage medium in various forms, such as a volatile memory and/or a non-volatile memory. The volatile memory may include, but not limited to, for example, a random-access memory (RAM), a cache, and so on. The non-volatile memory may include, but not limited to, for example, a read only memory (ROM), a hard disk, a flash memory, and so on. Further, the at least memory 902 may include, but are not limited to, an electric, a magnetic, an optical, an electromagnetic, an infrared, or a semiconductor system, apparatus, or device or any combination of the above.

Further, in various embodiments, the example apparatus 900 may also include at least one other circuitry, element, and interface, for example at least one I/O interface, at least one antenna element, and the like.

In various embodiments, the circuitries, parts, elements, and interfaces in the example apparatus 900, including the at least one processor 901 and the at least one memory 902, may be coupled together via any suitable connections including, but not limited to, buses, crossbars, wiring and/or wireless lines, in any suitable ways, for example electrically, magnetically, optically, electromagnetically, and the like.

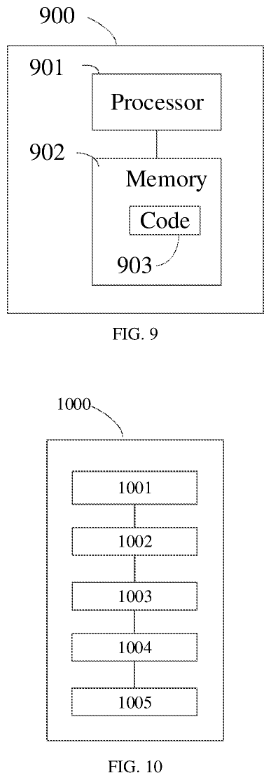

FIG. 10 illustrates an example apparatus 1000 for building corpus (e.g. the above corpus 101) for solution recommendation a software product (e.g. the above software product 105) in an embodiment.

As shown in FIG. 10, the example apparatus 1000 may include means for performing operations of the example method 800 described above in various embodiments. For example, the apparatus 1000 may include means 1001 for performing the operation 801 of the example method 800, means 1002 for performing the operation 802 of the example method 800, means 1003 for performing the operation 803 of the example method 800, means 1004 for performing the operation 804 of the example method 800, and means 1005 for performing the operation 805 of the example method 800. In one or more another embodiment, at least one I/O interface, at least one antenna element, and the like may also be included in the example apparatus 1000.

In some embodiments, examples of means in the apparatus 1000 may include circuitries. In some embodiments, examples of means may also include software modules and any other suitable function entities. In some embodiments, one or more additional means may be included in the apparatus 1000 for performing one or more additional operations of the example method 800.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and acts of the some embodiments described above can be combined to provide further embodiments. The accompanying claims and their equivalents are intended to cover such forms or modifications as would fall within the scope and spirit of the disclosure.

1. A method comprising:
obtaining a feature data set corresponding to a raw data set associated with a software product, feature data in the feature data set comprising at least one feature data item in terms of at least one similarity consideration for raw data in the raw data set;
determining at least one similarity value group for the feature data set, a similarity value group comprising at least one similarity value between at least one feature data item in first feature data in the feature data set and at least one feature data item in second feature data in the feature data set;
determining at least one unified similarity factor with at least one weight for the at least one similarity consideration to the at least one similarity value group;
adjusting the at least one weight so that a deviation between the at least one unified similarity factor and at least one reference unified similarity factor is below a predetermined threshold; and
building a corpus comprising information on the feature data set and the at least one weight.

2. The method of claim 1 wherein the at least one similarity consideration comprises at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

3. The method of claim 1 further comprising:
determining at least one category for the feature data set.

4. The method of claim 1 wherein the raw data in the raw data set comprises at least one of: runtime data associated with the software product, software runtime footprint tree data associated with the software product, historical data associated with the software product, an issue description associated with the software product, at least one network package associated with the software product, at least one log associated with the software product, at least one source code associated with the software product, at least one test case associated with the software product, at least one file associated with the software product, at least one develop document associated with the software product, and at least one solution collection associated with the software product.

5. The method of claim 1 further comprising:
associating at least one feature data in the feature data set with at least one of at least one software code of the software product or at least one test case of the software product.

6. The method of claim 1 further comprising:
monitoring the software product to obtain the raw data set associated with software product at runtime.

7. A method comprising:
obtaining first feature data comprising at least one first feature data item in terms of at least one similarity consideration for raw data associated with a software product;
obtaining second feature data from a corpus associated with the software product, the second feature data comprising at least one second feature data item in terms of the at least one similarity consideration;
determining at least one similarity value between the at least one first feature item and at least one second feature item;
determining a unified similarity factor between the first feature data and the second feature data with at least one weight for the at least one similarity consideration to the at least one similarity value; and
generating a recommendation on the software product based on the unified similarity factor.

8. The method of claim 7 wherein the at least one similarity consideration comprises at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

9. The method of claim 7 or 8 wherein the recommendation comprises at least one of:
selecting at least one test case associated with the first feature data and at least one test case associated with the second feature data in a case where the unified similarity factor is below the predetermined threshold;
providing at least one of at least one recommendation item associated with the second feature data, at least one source code of the software product associated with the second feature data, or at least one test case of the software product associated with the second feature data, in a case where the unified similarity factor is above the predetermined threshold;
re-executing the software product with at least one recommended configuration parameter associated with the second feature data in a case where the unified similarity factor is above the predetermined threshold; Or
executing a set of test cases associated with the software product.

10. The method of claim 7 further comprising:
determining a category of the first data to obtain the second data from the corpus based on the category.

11. The method of claim 10 wherein the solution recommendation is generated based on at least one of the category or at least one feature data in the corpus in case where the unified similarity factor is below a predetermined threshold, the at least one feature data belonging to the category and at least one unified similarity factor between the at least one feature data and the first feature data being above another predetermined threshold.

12. The method of claim 7 further comprising:
obtaining the raw data associated with the software product, the raw data comprising at least one of runtime data associated with the software product, software runtime footprint tree data associated with the software product, historical data associated with the software product, an issue description associated with the software product, at least one network package associated with the software product, at least one log associated with the software product, at least one code associated with the software product, at least one test case associated with the software product, at least one file associated with the software product, at least one develop document associated with the software product, and at least one solution collection associated with the software product; and
obtaining the first feature data based on the raw data.

13. The method of claim 12 further comprising:
associating the first feature data with at least one of at least one software code or at least one test case associated with the software product.

14. The method of claim 7 further comprising:
monitoring the software product to obtain the raw data corresponding to the first feature data at runtime.

15. The method of claim 7 further comprising:
adjusting the at least one weight in a case where unified similarity factors between one or more feature data in the corpus and the first feature data are below a predetermined threshold.

16. An apparatus comprising:
at least one processor; and
at least one memory including computer program code, the at least one memory and the computer program code being configured to, with the at least one processor, cause the apparatus to perform obtaining a feature data set corresponding to a raw data set associated with a software product, feature data in the feature data set comprising at least one feature data item in terms of at least one similarity consideration for raw data in the raw data set,
determining at least one similarity value group for the feature data set, a similarity value group comprising at least one similarity value between at least one feature data item in first feature data in the feature data set and at least one feature data item in second feature data in the feature data set,
determining at least one unified similarity factor with at least one weight for the at least one similarity consideration to the at least one similarity value group,
adjusting the at least one weight so that a deviation between the at least one unified similarity factor and at least one reference unified similarity factor is below a predetermined threshold, and
building a corpus comprising information on the feature data set and the at least one weight.

17. The apparatus of claim 16 wherein the at least one similarity consideration comprises at least one of: an execution order of at least one executable unit, an execution number of the at least one executable unit, an execution depth of at least one executable unit, an execution width of at least one executable unit, information for determining at least one correlation coefficient, semantics of a description, and at least one topic of a text.

18. The apparatus of claim 16 wherein the at least one memory and the computer program code is configured to, with the at least one processor, cause the apparatus to further perform determining at least one category for the feature data set.

19. The apparatus of claim 16 wherein the raw data in the raw data set comprises at least one of: runtime data associated with the software product, software runtime footprint tree data associated with the software product, historical data associated with the software product, an issue description associated with the software product, at least one network package associated with the software product, at least one log associated with the software product, at least one source code associated with the software product, at least one test case associated with the software product, at least one file associated with the software product, at least one develop document associated with the software product, and at least one solution collection associated with the software product.

20. The apparatus of claim 16 wherein the at least one memory and the computer program code is configured to, with the at least one processor, cause the apparatus to further perform associating at least one feature data in the feature data set with at least one of at least one software code of the software product or at least one test case of the software product.

21.-47. (canceled)
